(19) United States
(12) Patent Application Publication
(10) Pub. No.: US 2015/0012492 A1
(43) Pub. Date: Jan. 8, 2015

(54) METHOD AND APPARATUS FOR REPLICATING DATA

(71) Applicant: ELECTRONICS AND TELECOMMUNICATIONS RESEARCH INSTITUTE, Daejeon (KR)

(72) Inventors: Chei Yol KIM, Daejeon (KR); Hong Yeon KIM, Daejeon (KR); Young Kyun KIM, Daejeon (KR)

(73) Assignee: ELECTRONICS AND TELECOMMUNICATIONS RESEARCH INSTITUTE, Daejeon (KR)

(21) Appl. No.: 14/082,962

(22) Filed: Nov. 18, 2013

(30) Foreign Application Priority Data
Jul. 2, 2013 (KR) 10-2013-0077380

(51) Int. Cl. G06F 17/30

(52) U.S. Cl. CPC G06F 17/30575
USPC 707/625

(57) ABSTRACT

In order to synchronize a file between transmitting and receiving nodes, when a file is changed, a hint provider of the transmitting node provides a change file and change information about the change file as a hint to a change log generator, the change log generator generates a change log with reference to the change file and the hint, and the generated change log is transmitted to the receiving node by a change log transmitter.

### CROSS-REFERENCE TO RELATED APPLICATION

This application claims priority to and the benefit of Korean Patent Application No. 10-2013-0077380 filed in the Korean Intellectual Property Office on Jul. 2, 2013, the entire contents of which are incorporated herein by reference.

### BACKGROUND OF THE INVENTION

(a) Field of the Invention

The present invention relates to a method and apparatus for replicating data.

(b) Description of the Related Art

For storage of important computing data, data duplication that maintains the same data in real-time in two or more machines or apparatuses may be necessary. For duplication of data, it is necessary to replicate data of different computing apparatuses.

An easiest method of synchronizing a file in two apparatuses is to transmit entire data of a changed file from a transmitting apparatus to a receiving apparatus. However, because the transmitting apparatus should transmit entire files every time, the method is very inefficient.

As a method of solving such a drawback, there is a method of equally maintaining data by giving and receiving a change log in which only a changed portion of a file is recorded. The transmitting apparatus transmits only changed data instead of entire data, and the receiving apparatus, having received the changed data updates only changed data, thereby maintaining synchronization. In this case, in order to find changed data, the receiving apparatus should compare files corresponding to a size of a specific unit (several bytes) from a first portion to an end portion of two files. Therefore, there is a problem that much time is consumed in finding a changed portion of a file.

### SUMMARY OF THE INVENTION

The present invention has been made in an effort to provide a method and apparatus for replicating data having advantages of efficiently replicating data using a minimum amount of computing resources and time.

An exemplary embodiment of the present invention provides a method of replicating data in a transmitting node that changes a file so as to synchronize a file between the transmitting node and a receiving node. The method includes: providing a change file and change information about the change file as a hint, when the file is changed; generating a change log with reference to the change file and the hint; and transmitting the change log to the receiving node.

The hint may include hint type information, the hint type information may include one of a first type representing that the change file has stored new data; a second type representing that a changed portion has been continued in the change file; and a third type representing that a size of actual data that is included in the change file is a threshold value or less while the change file stores new data.

A hint of the first type may include only the hint type information.

The generating of a change log may include generating a change log including data of the change file when receiving the hint of the first type.

A hint of the second type may include a position of a change start point and a size of change data.

The generating of a change log may include reading data corresponding to a size of the change data from a position of the change start point in the change file, when receiving the hint of the second type, and generating a change log including the read data.

A hint of the third type may include a position and a data size of a data start point in which actual data is written in the change file.

The generating of a change log may include reading data corresponding to the data size from a position of the data start point in the change file, when receiving the hint of the third type, and generating a change log including the read data.

Another embodiment of the present invention provides a data replication apparatus for notifying a change of a file in a computing node that changes the file. The data replication apparatus includes a hint provider, a change log generator, and a change log transmitter. The hint provider provides a change file and change information about the change file as a hint, when the file is changed. The change log generator generates a change log with reference to the change file and the hint. The change log transmitter transmits the change log to another computing node.

The hint may include hint type information, and the hint provider may represent a first type with the hint type information when the change file stores new data and may represent a second type with the hint type information when a change portion of the change file is continued.

The change log generator may generate a change log including data of the change file, when receiving a hint of the first type.

A hint of the second type may include a position of a change start point and a size of change data, and the change log generator may generate a change log by reading data corresponding to a size of the change data from a position of the data start point in the change file, when receiving a hint of the second type.

The hint provider may represent a third type with the hint type information, when a size of actual data that is included in the change file is a threshold value or less while the change file stores new data.

A hint of the third type may include a position and a data size of a data start point in which actual data is written in the change file, and the change log generator may generate the change log by reading data corresponding to the data size from a position of the data start point in the change file, when receiving the hint of the third type.

The hint provider may include a change file routine that provides a change file, when the file is changed, and a hint generator that provides change information about the change file as the hint.

### BRIEF DESCRIPTION OF THE DRAWINGS

FIG. 1 is a diagram illustrating a general method of replicating data.

FIG. 2 is a diagram illustrating an example of a method of generating a change log in a transmitting node of FIG. 1.

FIG. 3 is a block diagram illustrating an example of a method of generating a change log based on a hint in a transmitting apparatus according to an exemplary embodiment of the present invention.

FIG. 4 is a diagram illustrating an example of a hint that is provided in a case of a hint type 1 according to an exemplary embodiment of the present invention.

FIG. 5 is a diagram illustrating an example of a hint that is provided in a case of a hint type 2 according to an exemplary embodiment of the present invention.

FIG. 6 is a diagram illustrating an extension version of a hint type 2 according to an exemplary embodiment of the present invention.

FIG. 7 is a diagram illustrating an example of a hint that is provided in a case of a hint type 3 according to an exemplary embodiment of the present invention.

FIG. 8 is a block diagram illustrating a data replication apparatus of a node according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for replicating data according to an exemplary embodiment of the present invention will be described in detail with reference to the drawings.

A unit that stores and changes computing data may include a data block, which is a set of one byte to several hundred bytes and several thousand bytes, and when such data blocks are gathered and stored at a disk, a file may be used. A method and apparatus for replicating data that are suggested in an exemplary embodiment of the present invention can be applied to entire data units according to a range that performs synchronization. For convenience of description, in an exemplary embodiment of the present invention, it is assumed that a target unit of synchronization is a file, and a method and apparatus for replicating data according to an exemplary embodiment of the present invention will be described. It is assumed that an apparatus, which is a subject that performs synchronization, is a computing node that is connected to a network for convenience, and the computing node is briefly referred to as a node.

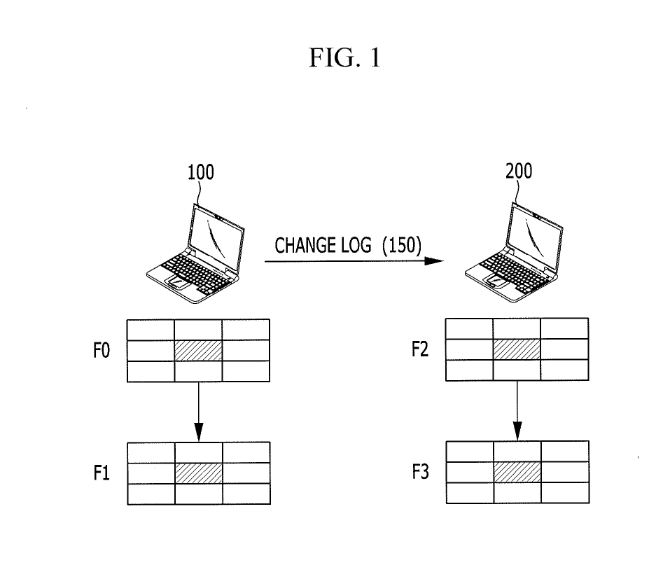

FIG. 1 is a diagram illustrating a general method of replicating data.

Referring to FIG. 1, in a transmitting node 100 of two nodes that perform synchronization, when a file F0 is changed to a file F1, the transmitting node 100 generates a change log 150 based on contents of the changed file F1 and transfers the change log 150 to a receiving node 200.

When the receiving node 200 receives the change log 150, by analyzing the change log 150, the receiving node 200 adjusts a file F2 and changes the file F2 to a file F3, thereby synchronizing the file F1 of the transmitting node 100 and the file F3 of the receiving node 200.

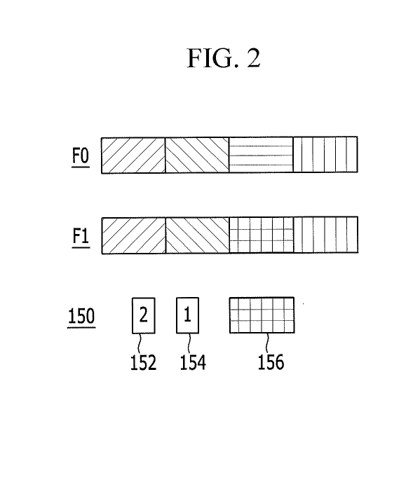

FIG. 2 is a diagram illustrating an example of a method of generating a change log in a transmitting node of FIG. 1.

Referring to FIG. 2, when the file F0 is changed to the file F1, the transmitting node 100 searches for only a changed portion while comparing two files F0 and F1 by a size of a specific unit from a first portion to an end portion.

Next, the transmitting node 100 generates a change log 150 in which a position 152 of a changed portion, a size 154 of changed contents, and changed contents 156 are displayed.

The receiving node 200 receives the change log 150 and writes the changed contents 156 at a corresponding position of the file F2 and thus the file F2 is changed to the file F3. Therefore, the receiving node 200 maintains the file F3 equally to the file F1 of the transmitting node 100.

However, because a method of generating a change log by comparing entire data of the files F0 and F1 generates the change log 150 without any information about the changed contents 156, in order to find the changed portion, entire files F0 and F1 should be compared. Particularly, when the changed portion is only a portion, most time is used for comparing unchanged data.

In an exemplary embodiment of the present invention, when changing a file, change information of the file is used when generating a change log and thus a method that can reduce a change log generation time is suggested. In a file change routine, when changing a file, change information about a file change is provided, and the change information is referred to as a hint. Further, this technique is called a hint-based data replicating technique.

Hereinafter, each hint that is used in an exemplary embodiment of the present invention will be described based on an exemplary embodiment.

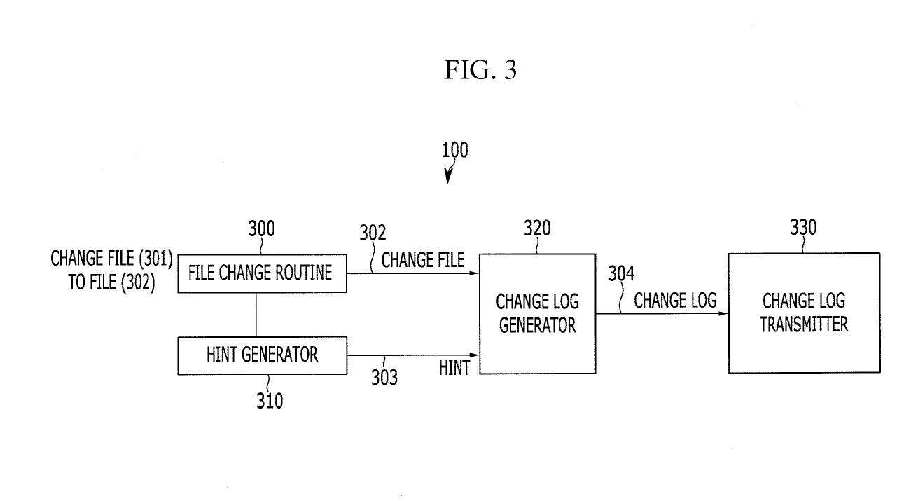

FIG. 3 is a block diagram illustrating an example of a method of generating a change log based on a hint in a transmitting apparatus according to an exemplary embodiment of the present invention.

Referring to FIG. 3, the transmitting node 100 includes at least one file change routine 300 that changes a file. Further, the transmitting node 100 includes a hint generator 310, a change log generator 320, and a change log transmitter 330.

At least one file change routine 300 transfers a change file 302 to the change log generator 320 whenever changing a file 301. Further, whenever the file is changed in the file change routine 300, the hint generator 310 transfers a hint 303 of the changed file to the change log generator 320.

When writing a change log of the change file 302, the change log generator 320 generates a change log 304 with reference to the hint 303 together with the change file 302.

When the change log generator 320 transfers the generated change log 304 to the change log transmitter 330, the change log transmitter 330 transfers the change log to the receiving node 200, and the receiving node 200 synchronizes a corresponding file, as in the transmitting node 100. Because a file change of a plurality of files may simultaneously occur in a plurality of file change routines 300, the change log generator 320 receives a plurality of hints to write a change log of each file.

Hints that may be provided by the hint generator 310 of the transmitting node 100 may be various according to a file change routine, and in an exemplary embodiment of the present invention, a method of three cases that may be most efficiently applied when writing a change log is suggested.

A first case is one in which the file after change 302 newly stores data without using contents of the file before change 301 as a base. In this case, the hint generator 310 provides such information as a hint to the change log generator 320, and such a hint corresponds to a hint type 1.

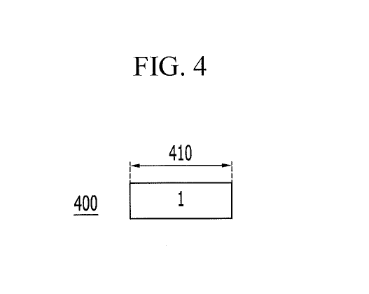

FIG. 4 is a diagram illustrating an example of a hint that is provided in a case of a hint type 1 according to an exemplary embodiment of the present invention.

Referring to FIG. 4, in the hint type 1, a hint 400 includes only a hint type 410.

When the change log generator 320 receives the hint 400 of the hint type 1, the change log generator 320 compares contents of the file before change 301 and the file after change 302, does not write a change log, writes a change log 304 including only contents of the file after change 302, and transfers the change log 304 to the change log transmitter 330.

A second case is one in which a changed portion is not distributed but is continuously formed. In this case, the hint generator 310 provides such information as a hint to the change log generator 320, and in this case, the provided hint corresponds to a hint type 2.

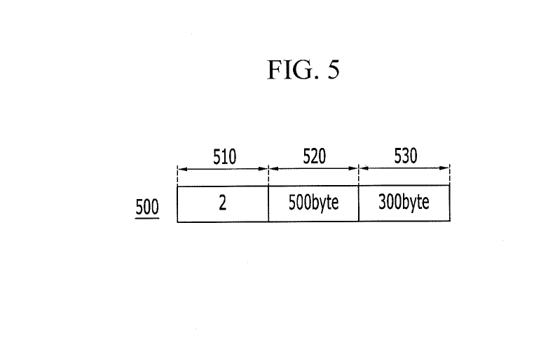

FIG. 5 is a diagram illustrating an example of a hint that is provided in a case of a hint type 2 according to an exemplary embodiment of the present invention.

Referring to FIG. 5, a hint 500 of the hint type 2 includes a hint type 510 and a point at which a change is started, i.e., a position 520 of a change start point, and a size 530 of change data. As shown in FIG. 5, a hint 500 in which the hint type 510 is 2, in which a position 520 of the change start point is 500, and in which a size of change data is 300 represents that data of 300 bytes are continuously changed from a 500 byte position of the file before change 301.

When the change log generator 320 receives the hint 500 of the hint type 2, the change log generator 320 does not compare the file before change 301 and the file after change 302, reads data of the file after change 302 with the position 520 of a change start point that is provided as the hint 500 and the size 530 of change data, and writes the change log 304. The hint 500 of the hint type 2 may be applied even when there are multiple changed portions of the file.

That is, the change log generator 320 reads data corresponding to a size of the change data from a position of a change start point in the change file 302 and generates a change log.

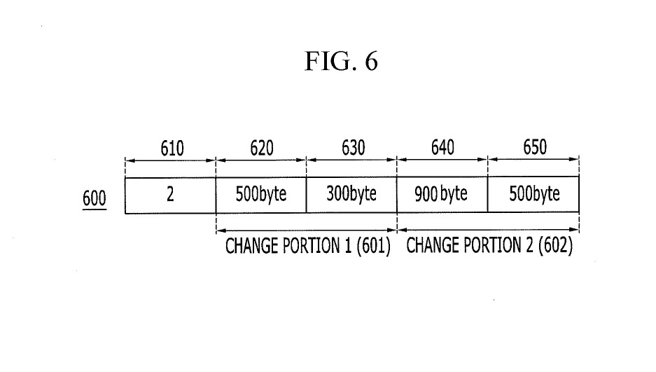

FIG. 6 is a diagram illustrating an extension version of a hint of the hint type 2 according to an exemplary embodiment of the present invention.

Referring to FIG. 6, a hint 600 of the hint type 2 (610) may include a plurality of change portions. It is illustrated that the hint 600 that is shown in FIG. 6 includes two change portions of a change portion 1 (601) and a change portion 2 (602).

Information about one change portion 601/602 includes a position 620/640 of a change start point and a size of change data 630/650, as shown in FIG. 6.

The change log generator 320, having received the hint of FIG. 6, reads information about the two change portions 601 and 602 that are provided in the hint 600, sequentially reads information of a changed portion up to an end portion of the hint 600 without comparing the file before change 301 and the file after change 302, and writes a change log 304.

Next, a hint type 3, which is a third case, is a case that newly writes contents of an entire file, as in the hint type 1, and is an effective hint type when a size of actual data that is included in a file is not large, compared with the entire size of the file. For example, there is a file having a size of 100 bytes, but when a size of a portion having actual data is only 10 bytes, if the file is transferred to a receiving node, data of 100 bytes, which is an entire size, should be sent. In this case, an area of a 90 byte size in which data is not written is filled with “0” and is sent. The hint type 3 represents a case in which such a file is generated, and in this case, the hint generator 310 notifies a portion in which actual data is written in the file as a hint and provides the hint to the change log generator 320.

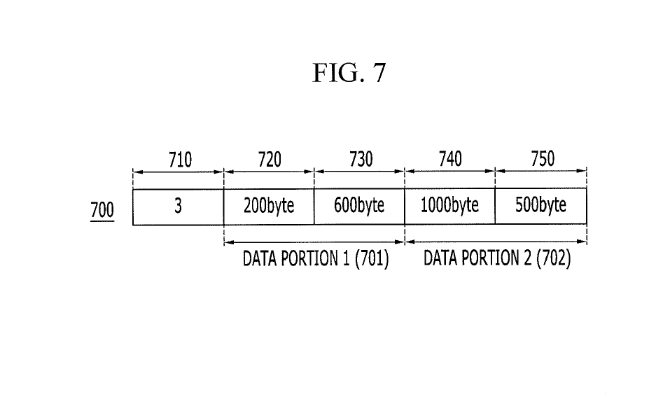

FIG. 7 is a diagram illustrating an example of a hint that is provided in a case of a hint type 3 according to an exemplary embodiment of the present invention.

Referring to FIG. 7, a hint 700 of the hint type 3 includes a hint type 710 and information 701 and 702 of a portion in which actual data is written in a corresponding change file 302. It is illustrated that the hint 700 that is shown in FIG. 7 includes information of a data portion 1 (701) and a data portion 2 (702), i.e., two data portions 701 and 702 in which actual data is written.

Information about each data portion 701/702 includes a position 720/740 of a data start point and a data size 730/750, as shown in FIG. 7.

As shown in FIG. 7, in the hint 700 in which a hint type 710 is 3 and in which positions 720 and 740 of data start points are 200 and 1000, respectively, and in which data sizes 730 and 750 are represented as 600 and 500, data of the first data portion 701 of the change file 302 is a portion of 600 bytes from a location in which a start position is 200 bytes, and data of a second portion is a portion of 500 bytes from a location in which a start position is 1000 bytes. That is, it can be seen from the hint that a size in which data is actually written in a corresponding file is 1100 bytes.

The change log generator 320, having received a hint of the hint type 3, reads only a portion in which actual data is written without reading the entire file after change 302 and generates a change log.

A case in which a hint is not provided may be advantageous. This indicates a wide change range. That is, this is a case in which the side that changes a file changes many portions of the file, and in this case, a log file is written using an existing method, and at this time, a hint is not provided.

When change contents of a file are not estimated, it is difficult to determine whether giving a hint is effective. However, when a file change is performed along a determined routine in a specific software code, it may be estimated how to change in a corresponding code and thus it may be determined whether a hint is effective.

An exemplary embodiment thereof may include duplication of metadata of a distribution file system. Metadata is data having information about a file system and is a very important element in a file system. Therefore, in order to safely keep metadata, duplication is necessary. For duplication, metadata that is changed whenever performing a service should be replicated to another node in real time. In this case, a change of metadata is performed in a metadata server and thus a metadata server knows operation of each service routine such that how metadata is changed may be estimated. In this case, an exemplary embodiment of the present invention generates a change log file based on a hint that is provided in a routine that changes a file instead of generating a log file by comparing with an existing file without any hint like an existing method, and thus can reduce a load and a time that are consumed when writing a log file.

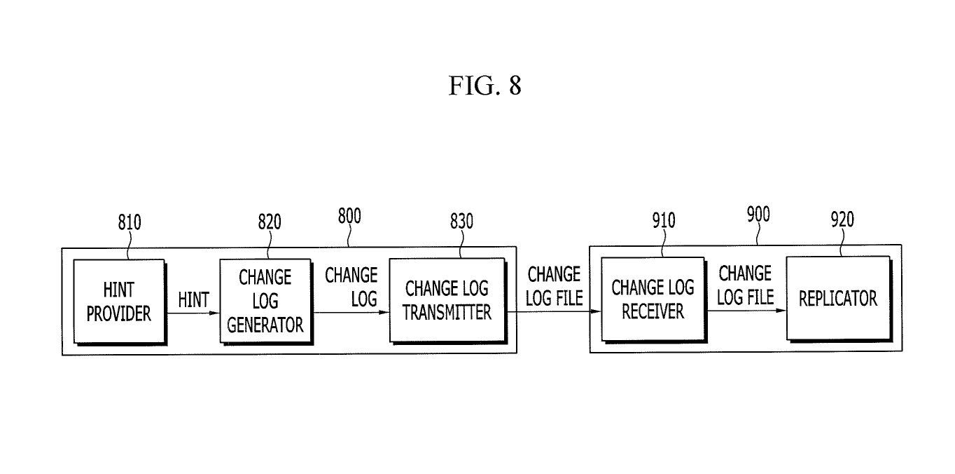

FIG. 8 is a block diagram illustrating a data replication apparatus of a node according to an exemplary embodiment of the present invention.

Referring to FIG. 8, the transmitting node 100 and the receiving node 200 include data replication apparatuses 800 and 900, respectively.

The data replication apparatus 800 of the transmitting node 100 includes a hint provider 810, a change log generator 820, and a change log transmitter 830.

The data replication apparatus 900 of the receiving node 200 includes a change log receiver 910 and a replicator 920.

In the data replication apparatus 800 of the transmitting node 100, the hint provider 810 may include the file change routine 300 and the hint generator 310 that are described with reference to FIG. 3. Further, in the data replication apparatus 800 of the transmitting node 100, the change log generator 820 and the change log transmitter 830 correspond to the change log generator 320 and the change log transmitter 330 that are described with reference to FIG. 3. That is, the change log generator 820 generates a change log using a hint that is provided in the hint generator 310, as described with reference to FIGS. 4 to 7. In this case, the change log generator 820 may generate a hint into a change log. The change log transmitter 830 transmits the generated change log to the receiving node 200.

In the data replication apparatus 900 of the receiving node 200, the change log receiver 910 receives a change log from the data replication apparatus 800 of the transmitting node 100. By analyzing the change log, the replicator 920 changes the file F2 of the receiving node 200 to the file F3. Thereby, the changed file F3 of the receiving node 200 becomes identical to the changed file F1 of the transmitting node 100.

A function of two transmitting and receiving nodes may be changed, as needed. Therefore, the node may include the data replication apparatus 800 of the transmitting node 100 and the data replication apparatus 900 of the receiving node 200.

According to an exemplary embodiment of the present invention, by using a hint-based data replicating technique, data can be efficiently replicated in two or more different apparatuses using a minimum amount of computing resources and time.

An exemplary embodiment of the present invention may be not only embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of replicating data in a transmitting node that changes a file so as to synchronize a file between the transmitting node and a receiving node, the method comprising:
providing a change file and change information about the change file as a hint, when the file is changed;
generating a change log with reference to the change file and the hint; and
transmitting the change log to the receiving node.

2. The method of claim 1, wherein the hint comprises hint type information, and
the hint type information comprises one of:
a first type representing that the change file has stored new data;
a second type representing that a changed portion has been continued in the change file; and
a third type representing that a size of actual data that is included in the change file is a threshold value or less while the change file stores new data.

3. The method of claim 2, wherein a hint of the first type comprises only the hint type information.

4. The method of claim 3, wherein the generating of a change log comprises generating a change log comprising data of the change file when receiving the hint of the first type.

5. The method of claim 2, wherein a hint of the second type comprises a position of a change start point and a size of change data.

6. The method of claim 5, wherein the generating of a change log comprises:
reading data corresponding to a size of the change data from a position of the change start point in the change file, when receiving the hint of the second type; and
generating a change log comprising the read data.

7. The method of claim 2, wherein a hint of the third type comprises a position and a data size of a data start point in which actual data is written in the change file.

8. The method of claim 7, wherein the generating of a change log comprises:
reading data corresponding to the data size from a position of the data start point in the change file, when receiving the hint of the third type; and
generating a change log comprising the read data.

9. A data replication apparatus for notifying a change of a file in a computing node that changes the file, the data replication apparatus comprising:
a hint provider that provides a change file and change information about the change file as a hint, when the file is changed;
a change log generator that generates a change log with reference to the change file and the hint; and
a change log transmitter that transmits the change log to another computing node.

10. The data replication apparatus of claim 9, wherein the hint comprises hint type information, and
the hint provider represents a first type with the hint type information when the change file stores new data and represents a second type with the hint type information when a change portion of the change file is continued.

11. The data replication apparatus of claim 10, wherein the change log generator generates a change log comprising data of the change file, when receiving a hint of the first type.

12. The data replication apparatus of claim 10, wherein a hint of the second type comprises a position of a change start point and a size of change data, and
the change log generator generates a change log by reading data corresponding to a size of the change data from a position of the data start point in the change file, when receiving a hint of the second type.

13. The data replication apparatus of claim 10, wherein the hint provider represents a third type with the hint type information, when a size of actual data that is included in the change file is a threshold value or less while the change file stores new data.

14. The data replication apparatus of claim 13, wherein a hint of the third type comprises a position and a data size of a data start point in which actual data is written in the change file, and
the change log generator generates the change log by reading data corresponding to the data size from a position of the data start point in the change file, when receiving the hint of the third type.

15. The data replication apparatus of claim 10, wherein the hint provider comprises:
a change file routine that provides a change file, when the file is changed; and
a hint generator that provides change information about the change file as the hint.
